(19) United States
(12) Patent Application Publication
(10) Pub. No.: US 2003/0050953 A1
(43) Pub. Date: Mar. 13, 2003

(54) Method of operating a computer system and apparatus

(76) Inventors: Lothar Feige, Berlin (DE); Stephan Riedel, Berlin (DE); Norbert Rose, Berlin (DE); Tilo Kaschubek, Berlin (DE)

Correspondence Address: SUTHERLAND ASBILL & BRENNAN LLP, 999 PEACHTREE STREET, N.E., ATLANTA, GA, 30309, US

(21) Appl. No.: 09/949,159

(22) Filed: Sep. 7, 2001

(51) Int. Cl. G06F 9/00

(52) U.S. Cl. 709/100

(57) ABSTRACT

A method of operating a computer system and apparatus. The invention relates to a method of operating a computer system as well as to a computer system within which a central processing unit (1) is connected to at least two digital signal processors (3.1-3.n) in a way to permit electronic data to be exchanged between the central processing unit (1) and the respective one of the at least two digital signal processors (3.1-3.n) which, upon request, each automatically execute digital calculating tasks to be performed by the computer system. With this method, information about the workload of the at least two digital signal processors (3.1-3.n) is acquired automatically with the assistance of detector means; and subsequently calculating operations are distributed with the assistance of distributor means to the at least two digital signal processors (3.1-3.n) in response to the workload detected of the at least two digital signal processors (3.1-3.n).

The invention relates to computer systems and specifically is concerned with computer systems including a central processing unit and at least two digital signal processors connected to the central processing unit and/or at least two programmable logic devices connected to the central processing unit, as well as networks which comprise one or more such computer systems.

In computer systems of the kind mentioned, the central processing unit makes use of digital signal processors and/or programmable logic devices for processing great quantities of electronic data, for example in connection with compressing, filtering, or encrypting electronic data. Such computing operations place an enormous workload on the central processing unit which can process them only relatively slowly as its technical structure usually is not optimized for performing such operations. For this reason the processing of data by the operations mentioned may cause delays in the handling of the data quantities. The central processing unit, therefore, relocates such operations by assigning them to the programmable logic devices and/or digital signal processors.

A digital signal processor is a processor which includes a plurality of internal arithmetic units so that it is adapted to carry out different multiplications and additions simultaneously. In many cases of application in practice, the digital signal processors can move electronic data in parallel with the solving of arithmetic problems. Digital signal processors, as a rule, are characterized by strict separation of program memories and data memories. This is sometimes referred to as hardware architecture. A programmable logic device is an assembly based on programmable, elementary Boolean operations and various flipflops.

Relocating certain operations from the central processing unit to the digital signal processors and/or the programmable logic devices increases the data exchange between the ressources of the computer system. This in turn may cause delays in the processing of data in the computer system.

It is the object of the invention to provide a method of operating a computer system of the kind specified initially as well as a computer system for carrying out the method, with which the efficiency of the computer system in processing operations is improved, especially by optimized utilization of given electronic resources.

This object is met, in accordance with the invention, by a method as defined in claim 1 and a data processing means as defined in claim 11.

An essential advantage achieved by the invention as compared to the state of the art is that the arithmetic operations and/or data movements to be dealt with by the computer system are performed in dependence on the particular workload of the digital signal processors which are connected to the central processing unit and/or the progammable logic devices which are connected to the central processing unit. In this manner it can be avoided that individual digital signal processors/programmable logic devices become overloaded, while other digital signal processors/programmable logic devices have unused free arithmetic or loading capacities. The efficiency of the computer system thus is improved by optimizing the utilization of given resources.

This novel distribution of the load between the digital signal processors/programmable logic devices permits an intelligent reaction to the workload of the respective elements or resources, whereby backlogs in data processing can be minimized or eliminated altogether.

When a plurality of central processing units, each connected to one or more digital signal processors and/or programmable logic devices, are coupled together so as to form a cluster or network, the load-responsive distribution of arithmetic problems to be solved by the network may be relied on for optimizing the capacity of the overall system. The cluster or network is a “lose” joining of individual computer systems (knodes) which each comprise at least one central processing unit with a memory of its own and a link to the network. Each knode has its own operating system.

According to an expedient further development of the invention it is determined, during the automatic gathering of information about the workload, whether the at least two digital signal processors are operated in a calculating mode or an idle mode at a predetermined point in time. In this manner it is possible to find out, in principle, the respective operating mode of the digital signal processor in question before going into a more detailed analysis of the workload. Here, the information of the operating state of the at least two digital signal processor at a particular given time, whetherÿit is calculating or idling, is comprised by the workload information.

A preferred embodiment of the invention provides for electronically determining an average workload over a time interval during the automatic acquiring of information regarding the workload of the at least two digital signal processors. That makes it possible to take into account the signal processors regardless of short-term peak loads or idle periods when distributing the digital calculating tasks.

Automatic acquisition of information about the average workload can be achieved by simple computing measures: during the automatic gathering of information about the workload of one or all of the digital signal processors the count of an electronic counter means is incremented continually during idling, whereas it remains unchanged during the calculating mode. When the average workload is determined electronically, a respective value, obtained from the division of the count by the time interval, is included automatically.

Alternatively, the average workload can be determined according to a useful further development of the invention by continually incrementing both the count of an electronic counter means during the idling mode and the count of another electronic counter means during the calculating mode to accomplish the automatic pick-up of the workload of one or all of the digital signal processors. In this case, when the average workload is determined electronically, a respective value is included automatically which results from the division of the count of the electronic counter means by the sum of the count of the electronic counter means plus the additional electronic counter means.

In an advantageous embodiment of the invention the execution of the digital arithmetic problems and/or the movement of data can be correlated in time when the tasks are distributed in response to the information acquired about the workload of the at least two digital signal processors, by automatically considering the digital tasks according to a respective position they hold in the order of a queue which is managed electronically by the central processing unit.

If the method is applied in a computer system which comprises at least two central processing units the digital tasks can be distributed, individually harmonized with the digital signal processors/programmable logic devices, by automatically taking into account an individual workload of the at least two digital signal processors in the distribution of the digital tasks to be performed in the network.

According to an expedient further development of the invention a common averaged degree of workload of the at least two digital signal processors automatically is allowed for when distributing the digital tasks to be performed in the network. In this manner the tasks to be performed can be distributed between groups of digital signal processors, and the distribution can be made on the basis of the averaged workload of the groups of signal processors.

In an advantageous embodiment of the invention, the novel method of operating a computer system may be applied also to computer systems comprising programmable logic devices with which the at least two digital signal processors are replaced by at least two programmable logic devices and/or the at least one other signal processor is replaced by at least one other programmable logic device.

The advantages listed above in connection with the respective method claims are realized correspondingly by the apparatus subclaims 12 and 13.

The invention will be described further, by way of example, with reference to the accompanying drawing, in which:

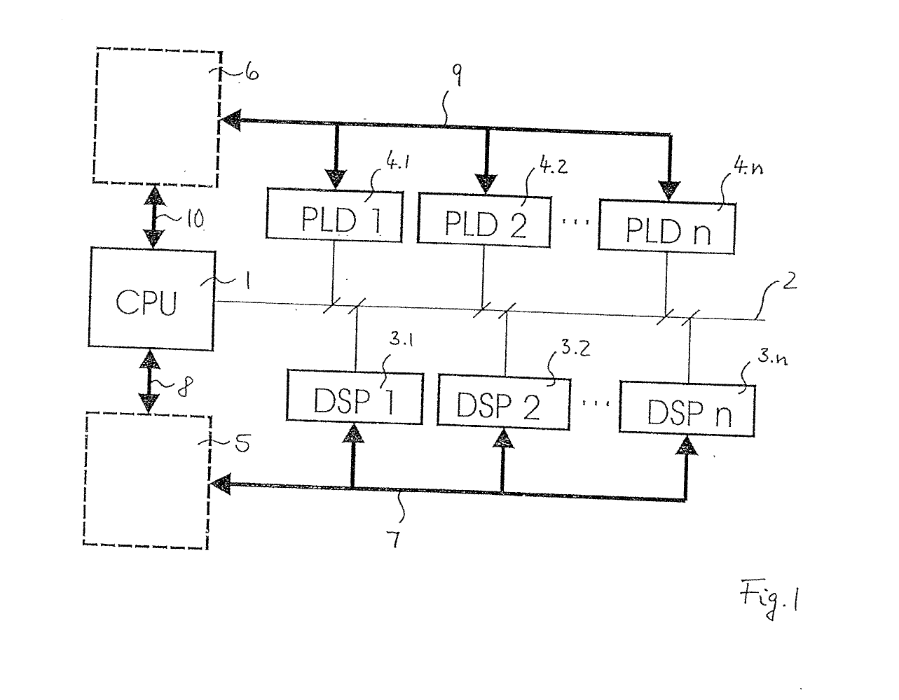

FIG. 1 is a block diagram of a computer system, and is a schematic representation of a network composed of several computer systems.

FIG. 1 illustrates a computer system which comprises a central processing unit CPU 1. The CPU 1 is connected by an internal bus 2 to a plurality of digital signal processors 3.1, 3.2 . . . 3.n (3.1-3.n) and a plurality of programmable logic devices 4.1, 4.2 . . . 4.n (4.1-4.n). Through the internal bus 2, data communication is established between the CPU 1 and the plurality of digital signal processors 3.1-3.n as well as the plurality of programmable logic devices 4.1-4.n.

The digital signal processors 3.1-3.n are used by the CPU 1 to have them solve arithmetic problems and, as they each comprise a plurality of internal arthimetic units, they can carry out different multiplications and additions simultaneously. As a rule, the signal processors also can move data in parallel with their execution of computing operations. The digital signal processors 3.1-3.n usually each have their own separate program memory and data memory (Havard architecture).

The programmable logic devices 4.1-4.n each are implemented in the form of an assembly with programmable, elemental Boolean operations and different flipflops.

Data communication between the CPU 1 and the various digital signal processors 3.1-3.n as well as between the CPU 1 and the various programmable logic devices 4.1-4.n is controlled and monitored by a communications driver 5 and 6, respectively. A queue of the calculating tasks and/or data to be transferred to the plurality of digital signal processors 3.1-3.n and the plurality of programmable logic devices 4.1-4.n, respectively, is managed in the communications drivers 5 and 6.

Arrows 7, 8, 9, 10 in FIG. 1 are intended to illustrate the data communication graphically. Physically, it takes place through the internal bus 2 between the CPU 1 and the digital signal processors 3.1-3.n and between the CPU 1 and the programmable logic devices 4.1-4.n, respectively. Electronic data are exchanged, as brokered by the respective communications driver 5 or 6, between the CPU 1 and the digital signal processors 3.1-3.n as well as between the CPU 1 and the programmable logic devices 4.1-4.n. Moreover, the CPU 1 passes additional functions or net lists through the internal bus 2 to the digital signal processors 3.1-3.n and the programmable logic devices 4.1-4.n for them to be carried out by these components in the course of their calculating operations or data movements. This makes it possible to have the signal processors 3.1-3.n and the programmable logic devices 4.1-4.n carry out processing steps which are not firmly installed in these components.

Arithmetic operations or parts thereof and movements of data for which time is a critical aspect or which require intense computing are passed by the CPU 1 to one of the communications drivers 5 or 6. The respective communications driver 5 or 6 enters the operations/partial operations received into its queue. From the digital signal processors 3.1-3.n and the programmable logic devices 4.1-4.n, respectively, the corresponding communications driver 5 or 6 receives electronic information about the instantaneous loading, i.e. information as to whether or not and/or to what extent the respective digital signal processor 3.1-3.n or programmable logic device 4.1-4.n is tied up in the execution of operations. This workload information further may include information about the workload of a subgroup of the digital signal processors 3.1-3.n or programmable logic devices 4.1-4.n.

The so-called FIFO (first in/first out) principle is applied in this context.

Once listed in the respective queue of the communications driver 5 or 6, the operations/partial operations will be transferred to the digital signal processors 3.1-3.n or programmable logic devices 4.1-4.n in response to the workload information received from the digital signal processors 3.1-3.n and programmable logic devices 4.1-4.n and in correspondence with their rank in the order of the queue. Preferably, first those operations/partial operations are transferred which are last in line in the corresponding queue. Upon transmission, the operation/partial operation is carried out by that or those digital signal processor(s) 3.1-3.n and by that or those programmable logic device(s) 4.1-4.n, respectively, to which it was passed on by the corresponding communications driver 5 or 6. After completion of the operation/partial operation, electronic data usually are transmitted in return to the respective communications driver 5 or 6 for subsquent further processing by the CPU 1.

If an operation/partial operation destined for one of the plurality of digital signal processors 3.1-3.n was transmitted to digital signal processor 3.2, for example, communications driver 5 will designate digital processor 3.2 as “busy”. As soon as the operation/partial operation is completed by digital signal processor 3.2, the communications driver 5 will designate digital processor 3.2 as “free” again and thus ready to take over new operations/partial operations. The procedure followed with the programmable logic devices 4.1-4.n is similar, making use of communications driver 6.

Alternatively or in addition to the information about the status (“free/busy”) of a respective digital signal processor or programmable logic device, the plurality of digital signal processors 3.1-3.n and programmable logic devices 4.1-4.n supply information to the associated communications driver 5 or 6 about their respective workload. Based on this information about the relative workload, the corresponding communications driver 5 or 6 is able to pass the operations from their place in the queue to the plurality of digital signal processors 3.1-3.n and programmable logic devices 4.1-4.n, respectively, in dependence on the respective workload of the individual components. Unnecessary blocking effects in the queues of the communications drivers 5 and 6 thus may be avoided.

In FIG. 1 the CPU 1 is connected both to a plurality of digital signal processors 3.1-3.n and a plurality of programmable logic devices 4.1-4.n. It is likewise conceivable (not shown) for one central processing unit to be connected only to a plurality of digital signal processors or only to a plurality of programmable logic devices. In these cases, too, the method of the invention of distributing operations from the central processing unit to the components connected to it in response to the workload of the components improves the respective computer system and contributes to preventing jamming in the execution of the operations.

The following procedure may be applied to electronically determine the workload of the digital signal processors 3.1-3.n and programmable logic devices 4.1-4.n, respectively. A count of an electronic counter means is incremented continually in the idle mode. When an associated digital signal processor 3.1-3.n or programmable logic device 4.1-4.n carries out an arithmetic operation (calculating mode) this is done in an interrupt mode (interrupt handler) which is not left until after completion of the calculation. The interrupt handler keeps the counter means from incrementing. That permits conclusions to be drawn regarding the workload of the digital signal processor or programmable logic device, by dividing the count of the electronic counter means by a fixed time interval.

It is likewise possible to install a timer interrupt which is triggered at fixed intervals for determining the workload. If a digital signal processor or programmable logic device concerned is to execute a calculating operation an entry address of the timer interrupt is changed and directed to a routine which increments a counter means 2. Upon completion of the calculation, a branch off to the old routine is taken which increments a counter means 1. The interrupt causes interruption both of idling and calculating, and the percentage workload is obtained by forming the following quotient: counter 2/(counter 1+counter 2). This novel method may be carried out also by drawing upon other electronic processes to determine the workload, provided the workload information needed for a load-responsive distribution of arithmetic operations is obtainable.

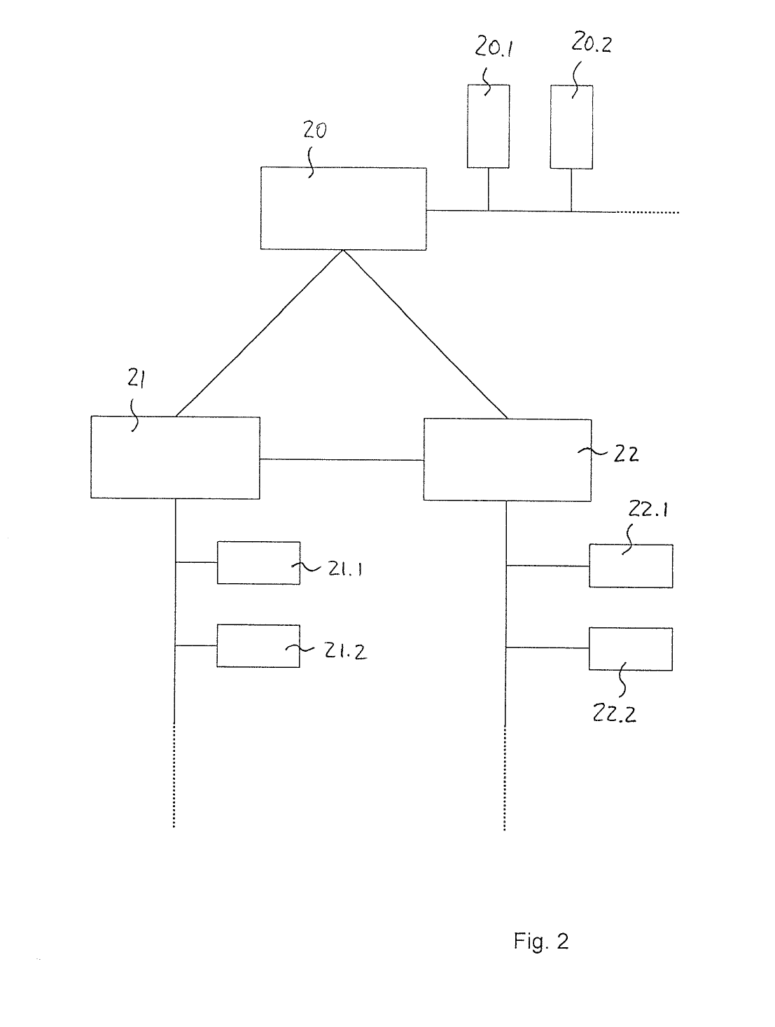

FIG. 2 is a diagrammatic illustration of a network or cluster comprising three central processing units CPU 20, CPU 21, CPU 22, each being connected to supplementary components 20.1, 20.2, 21.1, 21.2, and 22.1, 22.2, respectively. The supplementary components either are digital signal processors or programmable logic devices or a combination thereof. In any event, at least two each of programmable logic devices or digital signal processors always are provided. Each one of the CPU 20, CPU 21, CPU 22 comprises communications driver(s) as may be required for operating the supplementary components selected. The method described with reference to FIG. 1 of load-responsive distribution of operations may be carried out by the CPU 20, CPU 21, CPU 22 with the assistance of their respective communications driver(s). In addition, provision is made for the information about the operating state (“free/busy”) of the supplementary components 20.1, 20.2, 21.1, 21.2, and 22.1, 22.2 in question and/or the information about their respective workload to be transmitted to a network controller or cluster management. The latter cooperates with the CPU 20, CPU 21, CPU 22 to achieve a load-responsive distribution of the operations to be performed in the network, i.e. in the CPU 20, CPU 21, CPU 22, to the supplementary components 20.1, 20.2, 21.1, 21.2, and 22.1, 22.2. Again it may be provided to combine the information about the workload of several of the supplementary components 20.1, 20.2, 21.1, 21.2, and 22.1, 22.2, respectively, so that the workload of subgroups of the supplementary components will be available for electronic evaluation.

Thus the operations which the network must handle can be processed in optimum fashion as the various supplementary components are incorporated in accordance with their respective instantaneous loading. That helps avoid a situation where, for instance, the supplementary components 20.1, 20.2 of CPU 20 are totally overloaded, whereas the supplementary components 22.1, 22.2 of CPU 22 are not doing anything, i.e. are in the idle mode.

The network control in this arrangement may be installed either centrally in one of the CPU 20, CPU 21, CPU 22 or may be spread to all three of them.

The features disclosed in the specification above, in the claims, and drawings may be essential to implementing the invention in its various embodiments, both individually and in any desired combination.

What is claimed is:

1. A method of operating a computer system within which a central processing unit (1) is connected to at least two digital signal processors (3.1-3.n) in a way to permit electronic data exchange between the central processing unit (1) and the respective one of the at least two digital signal processors (3.1-3.n) which, upon request, each automatically execute digital tasks to be performed by the computer system, including in particular arithmetic problems and/or data movements, the method comprising:
automatically acquiring information about the workload of the at least two digital signal processors (3.1-3.n) with the assistance of detector means; and
subsequently distributing the digital tasks to the at least two digital signal processors (3.1-3.n) in response to the workload detected of the at least two digital signal processors (3.1-3.n) with the assistance of distributor means.

2. The method as claimed in claim 1, characterized in that during the automatic acquisition of information about the workload it is determined whether, at a predetermined point in time, the at least two digital signal processors (3.1-3.n) are being operated in a calculating mode or in an idle mode.

3. The method as claimed in claim 1 or 2, characterized in that an average workload over a time interval is determined electronically during the automatic acquisition of information about the workload of the at least two digital signal processors (3.1-3.n).

4. The method as claimed in claim 3, characterized in that a count of an electronic counter means is incremented continually during an idle mode while it remains unchanged during a calculating mode for the automatic acquisition of information about the workload of one or all of the digital signal processors (3.1-3.n), a value which results from the division of the count by the time interval being included automatically in the electronic determination of the average workload.

5. The method as claimed in claim 3, characterized in that a count of an electronic counter means is incremented continually during the idle mode and a count of another electronic counter means is incremented continually during the calculating mode for the automatic acquisition of information about the average workload of one or all of the digital signal processors (3.1-3.n), a respective value which results from the division of the count of the electronic counter means by the sum of the count of the electronic counter means and the count of the other electronic counter means being included automatically in the electronic determination of the average workload.

6. The method as claimed in any one of the preceding claims, characterized in that the digital tasks, when being distributed in response to the information acquired about the workload of the at least two digital signal processors (3.1-3.n), are automatically considered according to a respective position they hold in an order of a queue which is managed electronically by the central processing unit (1).

7. The method as claimed in any one of the preceding claims, the central processing unit (20) communicating with at least one other central processing unit (21, 22) so that the computer system is a network or cluster, and the at least one other central processing unit (21, 22) being connected to at least one other digital signal processor (21.1, 21.2 and 22.1, 22.2, respectively) which, upon request, executes digital tasks, including in particular arithmetic problems and/or data movements, characterized in that further information about the workload of the at least one other digital signal processor (21.1, 21.2 and 22.1, 22.2, respectively) is acquired automatically, this further information about the workload of the at least one other digital signal processor (21.1, 21.2 and 22.1, 22.2, respectively) and the information about the workload of the at least two digital signal processors (20.1, 20.2) are transmitted to network control means and processed automatically so as to automatically distribute digital tasks to be performed by the network to the at least two digital signal processors (20.1, 20.2) and the at least one other signal processor (21.1, 21.2 and 22.1, 22.2, respectively) in response to the information about the workload transmitted to the network control means.

8. The method as claimed in any one of the preceding claims, characterized in that an individual degree of workload of the at least two digital signal processors (20.1, 20.2) is automatically taken into account in the distribution of the digital tasks to be performed by the network.

9. The method as claimed in any one of the preceding claims, characterized in that a common averaged degree of workload of the at least two digital signal processors (20.1, 20.2) is automatically taken into account in the distribution of the digital tasks to be performed by the network.

10. The method as claimed in any one of claims 1 to 9, wherein at least two programmable logic devices (4.1-4.n) are used instead of the at least two digital signal processors (3.1-3.n) and/or at least one other programmable logic device is used instead of the at least one other signal processor.

11. A data processing means comprising a central processing unit (1) and at least two digital signal processors (3.1-3.n) each connected to the central processing unit (1) and each being adapted, upon request, to automatically execute digital tasks to be performed by the data processing means, including in particular arithmetic problems and/or data movements, electronic data being exchangeable between a respective one of the at least two digital signal processors (3.1-3.n) and the central processing unit (1), characterized by monitoring means for monitoring the workload of the two digital signal processors (3.1-3.n) and distributor means for distributing the digital tasks to the at least two signal processors (3.1-3.n) in response to the workload.

12. The data processing means as claimed in claim 11, characterized by an electronic counter means each for the at least two digital signal processors (3.1-3.n), a count of the respective electronic counter means being adapted to be incremented continually during an idle mode of the at least two digital signal processors (3.1-3.n), while remaining unchanged during a calculating mode of the at least two digital signal processors (3.1-3.n).

13. The digital processing means as claimed in claim 11 or 12, the central processing unit (20) communicating with at least one other central processing unit (21, 22) so that the data processing means is a network, and the at least one other central processing unit (21, 22) being connected to at least one other digital signal processor (21.1, 21.2 and 22.1, 22.2, respectively) which executes digital tasks upon request, characterized by network control means for receiving and automatically processing information about the workload of the at least two digital signal processors (20.1, 20.2) and the workload of the at least one other signal processor (21.1, 21.2 and 22.1, 22.2, respectively) so as to automatically distribute digital tasks to be performed by the network to the at least two digital signal processors (20.1, 20.2) and the at least one other signal processor (21.1, 21.2 and 22.1, 22.2, respectively) in response to the information about the workload transmitted to the network control means.
